(19) United States
(12) Patent Application Publication
(10) Pub. No.: US 2025/0261164 A1
(43) Pub. Date: Aug. 14, 2025

(54) METHOD OF TRANSMITTING DOWNLINK SMALL DATA TRANSMISSIONS TO COMMUNICATION DEVICES CONFIGURED FOR SCHEDULED INACTIVATION OF A RECEIVER

(71) Applicant: Continental Automotive Technologies GmbH, Hannover (DE)

(72) Inventors: Rikin Shah, Langen (DE); David Gonzalez Gonzalez, Egelsbach (DE); Reuben George Stephen, Singapore (SG); Andreas Andrae, Frankfurt am Main (DE)

(73) Assignee: Continental Automotive Technologies GmbH, Hannover (DE)

(21) Appl. No.: 18/854,787

(22) PCT Filed: Apr. 4, 2023
(86) PCT No.: PCT/EP2023/058780

§ 371 Date: Oct. 7, 2024

(30) Foreign Application Priority Data
Apr. 5, 2022 (DE) 10 2022 203 379.5

(51) Int. Cl. H04W 68/00

(52) U.S. Cl. CPC H04W 68/005

(57) ABSTRACT

A first communication apparatus of a radio access network transmits paging messages to one or more second communication apparatus in accordance with a paging scheme. The one or more second communication apparatus configure their receivers to be enabled accordingly, while remaining in an operating mode in which they are not fully connected to the first communication apparatus. Small data transmissions may be transmitted from the first to the one or more second communication apparatus after appropriately configuring the receivers of the one or more second communication apparatus to be enabled, while remaining in the operating mode in which they are not fully connected to the first communication apparatus. The required configuration information, in particular a periodicity of a traffic pattern and/or radio resources used for transmitting, is transmitted by the first communication apparatus in a paging message.

### CROSS-REFERENCE TO RELATED APPLICATIONS

The present application is a National Stage Application under 35 U.S.C. § 371 of International Patent Application No. PCT/EP2023/058780 filed on Apr. 4, 2023, and claims priority from German Patent Application No. 10 2022 203 379.5 filed on Apr. 5, 2022, in the German Patent and Trademark Office, the disclosures of which are herein incorporated by reference in their entireties.

### TECHNICAL FIELD

The present invention relates to handling small data transmission (SDT) to user equipment (UE) in radio access networks (RAN), in particular when a receiver of the UE is in an inactive state.

### BACKGROUND

In today's connected world many devices are connected to other devices or systems through wireless connections. Such devices may include portable or mobile devices, sensors, and even motor vehicles. Typically, such devices communicate with each other through a wireless network infrastructure, also referred to as radio access network (RAN), such as the well-known 3G, 4G, 5G and future communication networks. Depending on the direction of a transmission the communication through a wireless network infrastructure is typically referred to as uplink or downlink. Uplink (UL) relates to communication from a UE to the RAN, more specifically to a base station thereof, also referred to as gNB, while downlink (DL) relates to communication from the RAN to a UE.

The UE may implement various measures for reducing energy consumption, which is of significant importance in particular in battery-powered devices. One of the energy-saving mechanisms includes periodically inactivating a radio resource, and activating it only at certain times, inter alia during an operating mode also referred to as RRC_INACTIVE. RRC_INACTIVE is an operating mode that may be selected when a UE is not actively communicating with the RAN. While a UE is in the RRC_INACTIVE operating mode, the RAN, via a gNB the UE is logically attached to, periodically contacts the UE for ascertaining its presence within the radio range and its availability for communication. These periodic checks occur during so-called paging cycles. The UE will configure the cyclic activation and deactivation of electronic components necessary for receiving transmissions in accordance with the paging cycles, as determined by the radio access network.

The paging of a UE through a gNB of a radio access network does not fully connect the UE to the radio access network. Rather, the UE remains in RRC_INACTIVE operating mode. This avoids the protocol overhead associated with establishing a full connection to a gNB, which takes time and consumes resources both at the UE and the gNB.

A gNB may transmit small amounts of data in the DL to the UE when paging the UE, i.e., during the short periods in which the UE's receiver known is to be active, which is also referred to as small data transmission (SDT). However, there may be occasions when the amount of data to be transmitted to the UE exceeds the amount of data that can be transmitted during the short periods in which the UE's receiver is active. While the SDT may be completed by splitting the data into segments and transmitting a series of segments at suitable times, waiting for the next paging cycles of the UE for completing the SDT may be impractical, and keeping a receiver in an active state until the transmission of the data is completed may counter energy saving efforts.

To reduce signalling overhead and latency, 3GPP TS 38.331 Release 17 introduced support for mobile-originated SDT in RRC inactive mode. A simplified schematic flow diagram of the SDT in this case is shown in FIG. 1. The UE, while in the RRC_INACTIVE operating mode, determines, in step 10, if it has data to transmit to the RAN. In the positive case, “yes”—branch of step 10, the UE, in step 12, will perform the RACH procedure, RACH being the abbreviation for random access channel, and the RACH procedure normally serves for connecting and synchronising the UE to the best gNB of the RAN. A small amount of data may be transmitted in the RACH procedure without transitioning from the RRC_INACTIVE operating mode to a fully connected state, i.e., RRC_CONNECTED.

Current versions of 3GPP TS 38.331 do not specify mobile-terminated small data transmission in RRC_INACTIVE mode, and any mobile-terminated data transmission will require the UE to transition into the fully connected state, i.e., RRC_CONNECTED. A simplified schematic flow diagram of such mobile-terminated data transmission is shown in FIG. 2. In step 20 the RAN determines if there is data to send to a UE in the DL while the UE is known to be in the RRC_INACTIVE operating mode. In the positive case, “yes”—branch of step 20, the gNB sends, in step 22, a paging message to the UE at the next UE's paging occasion. In step 24 the UE performs the RACH procedure to transit to the connected state, i.e., to the RRC_CONNECTED operating mode. When the UE is connected to the gNB, the gNB, in step 26, transmits the SDT to the UE. After the transmission the UE may go back to the RRC_INACTIVE operating mode, step 28. This way of RAN-to-UE SDT requires a significant signalling overhead, notably for transitioning to the RRC_CONNECTED operating mode and for going back to the RRC_INACTIVE operating mode, and exhibits significant latency, all the more so when only small amounts of data are to be transmitted like in SDT.

### BRIEF SUMMARY

There is, thus, a need to provide a mechanism for improved handling of SDT while a receiving communication apparatus is in an operating mode, in which electronic components required for receiving transmissions are periodically enabled and disabled in accordance with a schedule or scheme, e.g., the UE is in RRC_INACTIVE.

This object is achieved by the methods and the communication apparatus specified in the independent claims. Advantageous embodiments and developments are provided in the respective dependent claims.

The invention tries to resolve situations in which it is not specified if a RAN-initiated SDT during the paging period has any effect on the UE's paging cycle, which determines when the electronic components required for receiving transmissions are enabled, without leaving the RRC_INACTIVE state. Moreover, with gNB-initiated SDT, or DL SDT, it is unclear if the UE needs to additionally wake up or not outside the paging cycle, e.g., in case one or more subsequent DL SDT transmissions are planned.

In accordance with a first aspect of the invention a method of operating a first communication apparatus is presented, for configuring a second communication apparatus to receive small data transmission while the second communication apparatus is in a first operating mode. In the first operating mode electronic components necessary for receiving transmissions are periodically enabled for brief time periods and disabled in between, in accordance with a schedule, scheme, or paging cycle that is configured in accordance with information received from the first communication apparatus. The expressions schedule, scheme, or paging cycle are used interchangeably throughout this specification unless different meanings are clear from the respective context. Likewise, transmissions from the first communication apparatus to the second communication apparatus occurring throughout the paging cycle or in accordance with the schedule or scheme are referred to as paging messages, irrespective of the expression used for the paging cycle, i.e., schedule or scheme, unless a different meaning is clear from the respective context.

The method in accordance with the first aspect of the invention comprises transmitting a paging message to the second communication apparatus in accordance with the paging cycle. The paging message includes or is complemented by a signal indicating properties of an impending small data transmission to the second communication apparatus. Throughout this specification the term “properties” is used in its broadest sense, referring to all kinds of properties of small data transmission in the DL, including traffic characteristics of the small data transmission in the DL, physical and logical characteristics of the small data transmission, and the like.

The properties may comprise, inter alia, an indication if the impending small data transmissions are transmitted in periodic intervals, i.e., in accordance with a periodic traffic pattern, or aperiodically, i.e., not following a periodic traffic pattern.

If a small data transmission in periodic intervals is indicated, the method further comprises transmitting the small data in the DL to the second communication apparatus in accordance with a periodicity of the traffic pattern also indicated in connection with the paging message, independently from the paging cycle.

In one or more embodiments the properties of an impending small data transmission further comprise information concerning a configuration of radio resources which are used in connection with transmitting the small data in the DL. Such information may relate, e.g., to dedicated and/or shared configured grant (CG) radio resources. Dedicated radio resources are configured through signalling specific to the second communication apparatus, whereas shared radio resources are configured through system information and are common for multiple second communication apparatus. The dedicated and/or shared CG resources may be used for receiving an acknowledgement, from the second communication apparatus, of the paging message or of received transmissions, and for transmitting the of the small data in the DL to the second communication apparatus. If the second communication apparatus fails to send an acknowledgement, or sends a signal indicating a transmission error, the first communication apparatus will retransmit the small data.

Dedicated CG resources will be valid for a predetermined time period configured by the RAN, e.g., through a RRC connection release message, or in accordance with a configured paging cycle, e.g., through a paging message. Dedicated radio resources are generally contention-free, whereas shared radio resources are contention-based. As long as a dedicated radio resource is configured for a second communication apparatus it will not use a shared radio resource that may also be configured.

The predetermined time during which the dedicated resources remain valid may be configured through a timer value that is transmitted, from the first communication apparatus to the second communication apparatus, at the occasion when the information about the periodic traffic pattern is received. The dedicated CG resource is released when the timer expires. If a small data transmission is not complete at the time the timer has expired, the remainder of the small data transmission may be transmitted on a shared radio resource.

The RAN may configure the timer for the dedicated CG resource in accordance with the amount of data that will be sent in each small data transmission, considering the communication needs of other second communication apparatus that happen to be attached to or registered with the same first communication apparatus. The RAN may configure the timer to extend over one additional wake up cycle in accordance with the periodicity of the small data transmission, or to extend over multiple subsequent wake up cycles.

The timer may be retriggered each time a small data transmission is transmitted by the first communication apparatus. An example for retriggering the timer is shown in FIG. 4. At t1 the RAN, through a first communication apparatus gNB, transmits a paging message to the second communication apparatus UE. The paging message carries information for configuring the communication resources. For example, an RRC_release message may be transmitted for configuring the timer in accordance with which the dedicated CG resource will be available for communicating. At t2, while the timer is not expired, indicated by the upper hashed rectangle, the first communication apparatus gNB transmits small data to the second communication apparatus UE. This retriggers the timer in both the first and second communication apparatus, indicated by the lower hashed rectangle. At t3, while the retriggered timer is not expired, the second communication apparatus transmits, via the dedicated CG resource, an acknowledgement for the small data transmission. As the small data transmission was properly received, and no retransmission is required, the timer is not retriggered by a further transmission from the first communication apparatus, and it expires at t4.

In one or more embodiments, if a small data transmission in periodic intervals is indicated, the method in accordance with the first aspect of the invention further comprises transmitting a number of subsequent transmissions to the second communication apparatus, after transmission of which the second communication apparatus may stop listening for transmissions from the first communication apparatus in periodic intervals. Alternatively, the final transmission may be indicated through a separate channel, e.g., in a downlink control information (DCI) message, and the second communication apparatus may accordingly stop listening for transmissions from the first communication apparatus in periodic intervals after the final transmission is over.

In one or more embodiments, if an aperiodic traffic pattern is indicated, the method in accordance with the first aspect of the invention further comprises transmitting the small data to the second communication apparatus at occasions of the paging cycle, i.e., the first communication apparatus will transmit small data whenever the electronic components necessary for receiving transmissions of the second communication apparatus are enabled in accordance with the schedule, scheme, or paging cycle.

In accordance with a second aspect of the invention a first communication apparatus of a radio access network comprises one or more microprocessors, volatile and non-volatile memory, and wireless receiver and transmitter means. The aforementioned components are communicatively connected via at least one data connection or bus. The non-volatile memory comprises computer program instructions which, when executed by the one or more microprocessors control the wireless receiver and transmitter means to establish, maintain and terminate communication connections with one or more second communication apparatus in accordance with a fourth aspect of the invention. The non-volatile memory further stores computer program instructions which, when executed by the one or more microprocessors, configure the first communication apparatus to implement and execute the method or embodiments thereof in accordance with the first aspect of the invention.

In accordance with a third aspect of the invention a method of operating a second communication apparatus for receiving small data transmission from a first communication apparatus, while the second communication apparatus is in a first operating mode, is presented. In the first operating mode electronic components necessary for receiving transmissions are periodically enabled for brief time periods and disabled in between, in accordance with a paging cycle configured in accordance with information received from the first communication apparatus. The method comprises receiving, from the first communication apparatus, a signal indicating properties of an impending small data transmission to the first communication apparatus during a time period, in which the electronic components necessary for receiving transmissions are enabled in accordance with the paging cycle.

The properties may comprise, inter alia, an indication if the small data transmission is transmitted in periodic intervals, i.e., in accordance with a periodic traffic pattern, or aperiodically, i.e., not following a periodic traffic pattern. The indication of a periodic or aperiodic traffic pattern may be signalled by a single bit transmitted in connection with a paging message. Accordingly, the method further comprises determining, if the properties in the received signal indicate that the impending small data transmission follow a periodic pattern. In the positive case, the method further comprises determining, from the received signal indicating properties of an impending small data transmission, a periodicity of the traffic pattern. In the positive case, the method yet further comprises additionally enabling the electronic components necessary for receiving the small data transmission to the first communication apparatus in accordance with the periodicity of the traffic pattern, independently from the paging cycle.

In one or more embodiments the method in accordance with the third aspect of the invention further comprises, if a periodic traffic pattern for the small data transmission is indicated, determining, from the received signal indicating properties, configuration information for the radio resources used in connection with the small data transmission. The configuration information may relate, e.g., to dedicated and/or shared configured grant (CG) radio resources.

In other words, the times at which the electronic components of the second communication apparatus, necessary for receiving transmissions, are enabled and disabled, respectively, in accordance with the paging cycle, need not be modified in the second communication apparatus. Rather, the electronic components of the second communication apparatus, necessary for receiving transmissions, are additionally enabled and disabled independent of the paging cycle, in accordance with the periodicity of the traffic pattern determined from the received signal and while the small data transmission is not completed. This enables the second communication apparatus to receive transmissions in between paging cycles, without connecting to the first communication apparatus.

The first communication apparatus may continue the scheduled activation or inactivation of the electronic components necessary for receiving transmissions in accordance with the paging cycle throughout and beyond the transmission of the small data transmission.

In one or more embodiments the method in accordance with the third aspect of the invention further comprises, if a periodic traffic pattern for the small data transmission is indicated, receiving, from the first communication apparatus, a number of subsequent transmissions, after completion of which the second communication apparatus may stop listening for transmissions from the first communication apparatus in periodic intervals. Alternatively, the final transmission may be indicated through a separate channel, e.g., in a downlink control information (DCI) message, and the second communication apparatus may accordingly stop listening for transmissions from the first communication apparatus in periodic intervals after the final transmission is over.

In one or more embodiments the method in accordance with the third aspect further comprises, if an aperiodic traffic pattern is indicated, enabling the electronic components necessary for receiving transmissions, for receiving the small data transmission to the first communication apparatus in accordance with the paging cycle.

In accordance with a fourth aspect of the invention a second communication apparatus of a radio access network comprises one or more microprocessors, volatile and non-volatile memory, and wireless receiver and transmitter means. The aforementioned components are communicatively connected via at least one data connection or bus. The non-volatile memory comprises computer program instructions which, when executed by the one or more microprocessors control the wireless receiver and transmitter means to establish, maintain and terminate communication connections with a first communication apparatus in accordance with the second aspect of the invention. The non-volatile memory further stores computer program instructions which, when executed by the one or more microprocessors, configure the second communication apparatus to implement and execute the method or embodiments thereof in accordance with the third aspect of the invention.

Using transmitted information about a periodicity of impending SDT, as proposed by the present invention, advantageously permits the UE to know whether or not it has to enable the electronic components required for receiving further transmissions in connection with an SDT. The invention may be used to great advantage in radio-connected sensors, IoT devices, and generally all radio-connected devices running on battery power. The electronic components of the UE may be disabled at any time when they need not be enabled in accordance with the paging cycle or the periodicity of the SDT.

Transmitting small amounts of DL data without going from an RRC_INACTIVE operating mode to an RRC_CONNECTED operating mode not only reduces the energy consumption, but also results in a reduced signalling overhead, freeing resources for other tasks in the RAN.

The electronic components controlled by executing the methods described hereinbefore may be part of or form a receiver including, inter alia, a radio frequency modem, a baseband receiver, and the like. This may help maintaining a low energy consumption in the UE, while being capable of receiving the entire transmission.

While the invention has been described with a focus on a radio access network in accordance with the 3GPP TS 38.211, TS 38.212, TS38.213, TS 38.300, TS 38.321 and TS 38.331 standard family, also referred to as 5G NR, it may also be used in further developments thereof, e.g., the future 6G standard. Also, while the invention has been described with a focus on the RRC_INACTIVE operating mode, it is not limited thereto, but may be used in all wireless systems in which UEs need to connect to network infrastructure for data transmission and reception and disable a receiver when not actively communicating, and which provide a mechanism via which small amounts of data can be transmitted without fully connecting to the network infrastructure. In particular, any term used in this specification for identifying a component or device, such as gNB for a base station of the RAN, is not meant to limit the invention to standards using the very same terms for components or devices performing the same function.

### BRIEF DESCRIPTION OF THE DRAWINGS

In the following section the invention will be described with reference to the figures. The examples provided in the figures are illustrative only, and should not be considered limiting the scope of the claims.

FIG. 1 shows a simplified schematic flow diagram of a known method of mobile-originated small data transmission.

FIG. 2 shows a simplified schematic flow diagram of a known method of mobile-terminated data transmission.

FIG. 3 shows a simplified schematic flow diagram of a method of mobile-terminated data transmission in accordance with the present invention.

FIG. 4 shows an exemplary timing diagram of keeping dedicated CG resources valid through a timer.

FIG. 5 shows a simplified schematic flow diagram of a method in accordance with the invention executed in a first communication apparatus.

FIG. 6 shows a simplified schematic flow diagram of a method in accordance with the invention executed in a second communication apparatus.

FIG. 7 shows a schematic block diagram of a first or second communication apparatus.

In the figures identical or similar elements may be referenced using the same reference designators.

### DETAILED DESCRIPTION

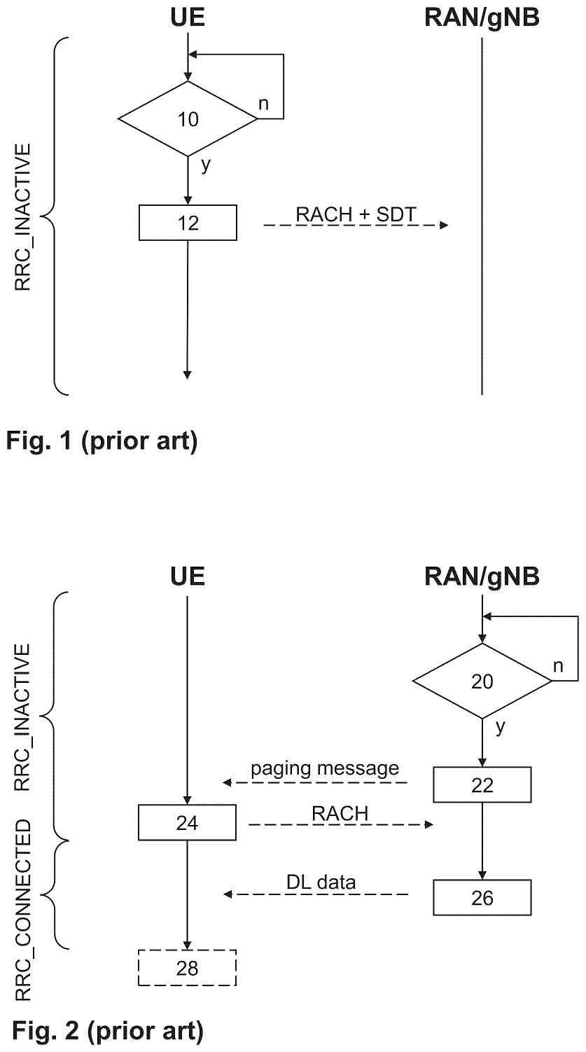

FIGS. 1, 2, and 4 have been discussed further above with regard to the prior art and will not be discussed again.

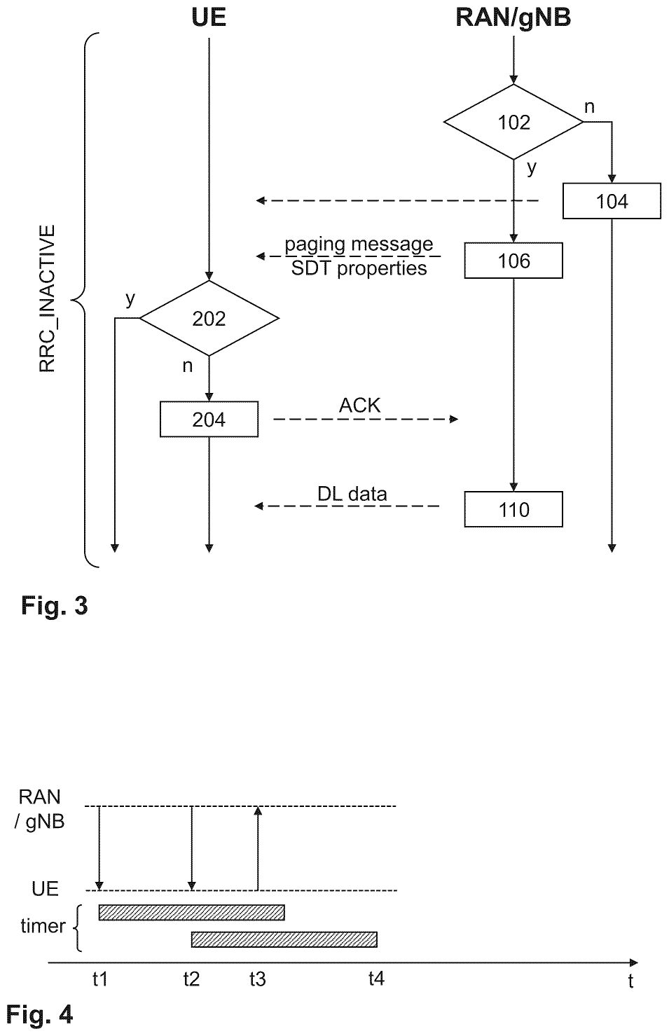

FIG. 3 shows a simplified schematic flow diagram of a method of mobile-terminated data transmission in accordance with the present invention. In step 102 the RAN/gNB determines if an SDT to the UE is to be initiated. In the negative case, “no”—branch of step 102, a regular paging message is sent to the UE in step 104, and the method is repeated in accordance with the paging cycle. In the positive case, “yes”—branch of step 102, a paging message with properties of an impending SDT is sent to the UE in step 106. In step 202 the UE determines if the received paging message is a regular one. In the positive case, “yes”—branch of step 202, the UE reacts to the paging message in the commonly known way. In the negative case, i.e., the paging message additionally carries properties of an impending SDT, “no”—branch of step 202, the UE, in step 204, acknowledges the impending SDT and enables the electronic components required for receiving transmissions in accordance with the properties received in connection with the paging message, in particular in accordance with an indicated periodicity. In step 110 the gNB transmits the small data accordingly.

The properties may, inter alia, comprise an indication of impending subsequent small data transmissions. A traffic characteristic, e.g., if the subsequent small data transmissions will be periodic or aperiodic, may be indicated using a single bit in the paging message. A value 1 of that bit may be used for indicating subsequent small data transmissions following a periodic pattern, while a value of 0 of that bit may be used for indicating that the subsequent small data transmissions do not follow a periodic pattern.

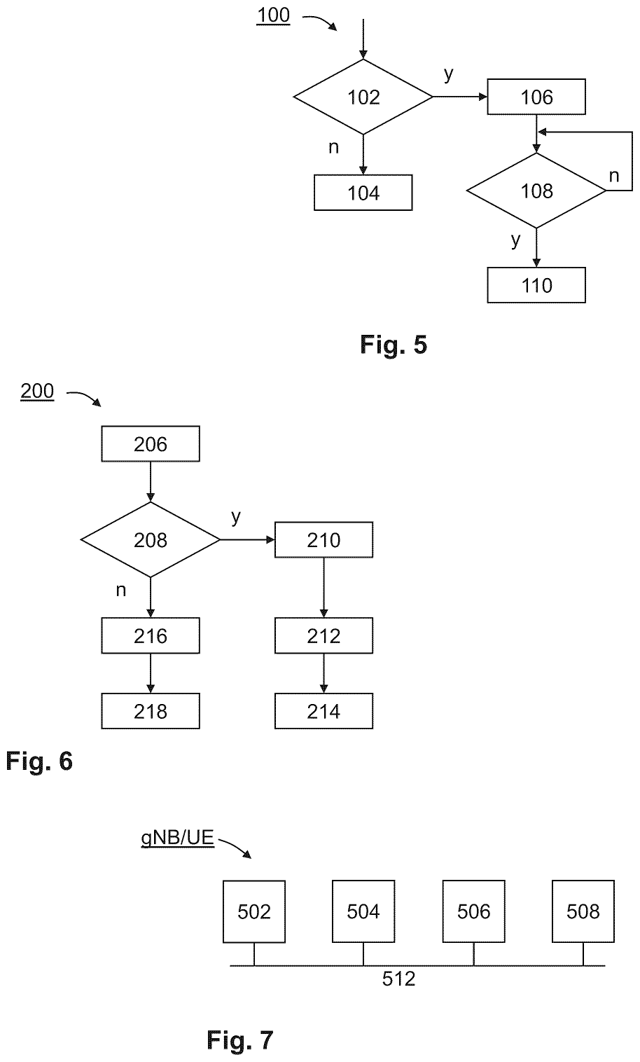

FIG. 5 shows a simplified schematic flow diagram of a method 100 in accordance with the invention executed in a first communication apparatus gNB. In step 102 the first communication apparatus gNB determines, if a small data transmission is to be sent to the second communication apparatus UE. In the negative case, “no”—branch of step 102, the first communication apparatus gNB sends, in step 104, a regular paging message in accordance with the paging cycle. In the positive case, “yes”—branch of step 102, the first communication apparatus gNB sends, in step 106, a paging message with properties of an impending SDT to the second communication apparatus UE. The first communication apparatus gNB waits, step 108, for a confirmation from the second communication apparatus UE, and once the confirmation is received, the first communication apparatus gNB transmits, in step 110, the small data transmission in accordance with the properties transmitted in step 106.

FIG. 6 shows a simplified schematic flow diagram of a method 200 in accordance with the third aspect of the invention executed in a second communication apparatus UE. In step 206 the second communication apparatus UE receives, from a first communication apparatus gNB, a signal indicating properties of an impending small data transmission to the second communication apparatus UE. In step 208 the second communication apparatus determines from the received properties, if the impending small data transmission is periodic. In the positive case, “yes”—branch of step 208, the second communication apparatus determines, in step 210, at least the periodicity of the impending small data transmission's traffic pattern, and configures enabling, in step 212, the electronic components required for receiving transmissions from the first communication apparatus in accordance with the periodicity received in the signal indicating properties of the impending small data transmission, in addition to the original paging cycle. In step 214 the second communication apparatus UE receives the small data transmission in accordance with the configured additional periodicity. If the impending small data transmission is not periodic, “no”—branch of step 208, the second communication apparatus UE enables, in step 216, the electronic components required for receiving transmissions from the first communication apparatus exclusively in accordance with the original paging cycle.

FIG. 7 shows a schematic block diagram of a first or second communication apparatus in accordance with the second and fourth aspect of the invention, respectively. The first and second communication apparatus gNB, UE of a radio access network comprise one or more microprocessors 502, volatile and non-volatile memory 504, 506, and wireless receiver and transmitter means 508, which are communicatively connected via at least one data connection or bus 512. The non-volatile memory 506 comprises computer program instructions which, when executed by the one or more microprocessors 502 control the wireless receiver and transmitter means 508 to establish, maintain and terminate communication connections between the first and the second communication apparatus, wherein the non-volatile memory 506 further stores computer program instructions which, when executed by the one or more microprocessors 502, configure the first and the second communication apparatus gNB, UE, respectively to implement and execute the method in accordance with the first or the third aspect of the invention.

LIST OF REFERENCE NUMERALS
(PART OF THE DESCRIPTION)

| | |
|---|---|
| 10 | UL data to send? |
| 12 | perform RACH procedure + |
| | transmit small data |
| 20 | DL data to send? |
| 22 | paging message |
| 24 | perform RACH procedure and go |
| | to RRC_CONNECTED |
| 26 | transmit DL data |
| 28 | go to RRC_INACTIVE |
| 100 | method (gNB) |
| 102 | DL data to send? |
| 104 | paging message |
| 106 | paging message + SDT properties |
| 108 | wait for confirmation |
| 110 | transmit SDT |
| 200 | method (UE) |
| 202 | regular paging message? |
| 204 | acknowledge + adjust enabling |
| | receiver |
| 206 | receive signal indicating |
| | properties of traffic pattern of |
| | impending SDT |
| 208 | periodic SDT? |
| 210 | determine at least periodicity of |
| | impending SDT |
| 212 | configure enabling receiver for |
| | periodic enabling |
| 214 | receive |
| 216 | enable receiver |
| 218 | receive SDT |
| 220 | transmission |
| | completed/terminated? |
| 222 | configure receiver for paging |
| | cycle |
| gNB | first communication apparatus |
| UE | second communication apparatus |

1. A method of operating a first communication apparatus for configuring a second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, the method comprising:
transmitting a paging message to the second communication apparatus, wherein the paging message includes or is complemented by a signal indicating properties of an impending small data transmission to the second communication apparatus.

2. The method of claim 1, further comprising, if a periodic traffic pattern is indicated:
transmitting the small data in the DL to the second communication apparatus in accordance with a periodicity of the traffic pattern also indicated in connection with the paging message, independently from the paging cycle.

3. The method of claim 1, wherein the properties of an impending small data transmission further comprise information concerning a configuration of radio resources which are used in connection with transmitting the small data in the DL.

4. The method of one of claim 1 wherein, if an aperiodic traffic pattern is indicated, the method further comprises transmitting number of subsequent transmissions, or indicating, through a separate channel, a final transmission, to the second communication apparatus, after transmission of which the second communication apparatus stops listening for transmissions from the first communication apparatus in periodic intervals.

5. The method of claim 1 wherein, if an aperiodic traffic pattern is indicated, the method further comprises transmitting the small data transmission to the second communication apparatus at occasions of the paging cycle.

6. A method of operating a second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, the method comprising:
receiving, from the first communication apparatus and during a time period of the paging cycle, in which the electronic components necessary for receiving transmissions are enabled, a signal indicating properties of an impending small data transmission to the second communication apparatus.

7. The method of claim 6, further comprising:
determining, if the properties in the received signal indicate a periodic traffic pattern for the impending small data transmission to the second communication apparatus, and
if a periodic traffic pattern is indicated:
determining, from the received signal, a periodicity of the traffic pattern, and
additionally enabling the electronic components necessary for receiving a the small data transmission to the first communication apparatus in accordance with the periodicity of the traffic pattern, independently from the paging cycle.

8. The method of claim 6 further comprising, if a periodic traffic pattern is indicated:
determining, from the received signal, configuration information for radio resources used in connection with the small data transmission.

9. The method of claim 8 further comprising, if a periodic traffic pattern is indicated:
receiving, from the first communication apparatus, a number of subsequent transmissions, after completion of which the second communication apparatus does not listen for transmissions from the first communication apparatus in periodic intervals, or
receiving, from the first communication apparatus, and through a separate channel, an indication of a final transmission, after completion of which the second communication apparatus does not listen for transmissions from the first communication apparatus in periodic intervals, and
accordingly cancelling additionally enabling the electronic components required for receiving transmissions from the first communication apparatus in accordance with the periodicity of the traffic pattern previously received.

10. The method of claim 6 wherein, if an aperiodic traffic pattern is indicated, the method further comprises enabling the electronic components necessary for receiving transmissions, for receiving the small data transmission to the first communication apparatus in accordance with the paging cycle.

11. A first communication apparatus of a radio access network comprising one or more microprocessors, volatile and non-volatile memory, and wireless receiver and transmitter, which are communicatively connected via at least one data connection or bus, wherein the non-volatile memory comprises computer program instructions which, when executed by the one or more microprocessors control the wireless receiver and transmitter to establish, maintain, and terminate communication connections with one or more second communication apparatus, wherein the non-volatile memory further stores computer program instructions which, when executed by the one or more microprocessors, configure the first communication apparatus to implement and perform operations comprising:
one of:
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus:
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, further comprising if a periodic traffic pattern is indicated: transmitting the small data in the DL to the second communication apparatus in accordance with a periodicity of the traffic pattern also indicated in connection with the paging message, independently from the paging cycle;
operating the first communication apparatus for configuring the second communication apparatus to receive small data transmission while the second communication apparatus is in a first operating mode in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein the properties of an impending small data transmission further comprise information concerning a configuration of radio resources which are used in connection with transmitting the small data in the DL;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein, if an aperiodic traffic pattern is indicated, transmitting number of subsequent transmissions, or indicating, through a separate channel, a final transmission, to the second communication apparatus, after transmission of which the second communication apparatus no longer listens for transmissions from the first communication apparatus in periodic intervals;
operating the first communication apparatus for configuring the second communication apparatus to receive small data transmission while the second communication apparatus is in a first operating mode, in which electronic components necessary for receiving transmissions are periodically enabled for brief time periods and or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein, if an aperiodic traffic pattern is indicated, transmitting the small data transmission to the second communication apparatus at occasions of the paging cycle.

12. The first communication apparatus of claim 11, further configured to establish, maintain, and terminate a wireless communication connection in accordance with 3GPP 5G and/or 6G standards.

13. A second communication apparatus comprising one or more microprocessors, volatile and non-volatile memory, and wireless receiver and transmitter, which are communicatively connected via at least one data connection or bus, wherein the non-volatile memory comprises computer program instructions which, when executed by the one or more microprocessors control the wireless receiver and transmitter to establish, maintain, and terminate communication connections with a first communication apparatus of a radio access network, wherein the non-volatile memory further stores computer program instructions which, when executed by the one or more microprocessors, configure the second communication apparatus to implement and perform operations comprising:
one of:
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving from the first communication apparatus and during a time period of the paging cycle, in which the electronic components necessary for receiving transmissions are enabled, a signal indicating properties of an impending small data transmission to the second communication apparatus;
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving from the first communication apparatus and during a time period of the paging cycle, in which the electronic components necessary for receiving transmissions are enabled, a signal indicating properties of an impending small data transmission to the second communication apparatus,
determining, if the properties in the received signal indicate a periodic traffic pattern for the impending small data transmission to the second communication apparatus, and if a periodic traffic pattern is indicated:
determining, from the received signal, a periodicity of the traffic pattern, and additionally enabling the electronic components necessary for receiving the small data transmission to the first communication apparatus in accordance with the periodicity of the traffic pattern, independently from the paging cycle;
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving, from the first communication apparatus and during a time period of the paging cycle, in which the electronic components necessary for receiving transmissions are enabled, a signal indicating properties of an impending small data transmission to the second communication apparatus, and if a periodic traffic pattern is indicated:
determining, from the received signal, configuration information for radio resources used in connection with the small data transmission;
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving, from the first communication apparatus and during a time period of the paging cycle, in which the electronic components necessary for receiving transmissions are enabled, a signal indicating properties of an impending small data transmission to the second communication apparatus, and if a periodic traffic pattern is indicated:
receiving, from the first communication apparatus, a number of subsequent transmissions, after completion of which the second communication apparatus does not listen for transmissions from the first communication apparatus in periodic intervals, or
receiving, from the first communication apparatus, and through a separate channel an indication of a final transmission, after completion of which the second communication apparatus does not listen for transmissions from the first communication apparatus in periodic intervals, and
accordingly cancelling additionally enabling the electronic components required for receiving transmissions from the first communication apparatus in accordance with the periodicity of the traffic pattern previously received.
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving, from the first communication apparatus and during a time period of the paging cycle in which the electronic components necessary for receiving transmissions are enabled, a signal indicating properties of an impending small data transmission to the second communication apparatus, wherein, if an aperiodic traffic pattern is indicated, enabling the electronic components necessary for receiving transmissions, for receiving the small data transmission to the first communication apparatus in accordance with the paging cycle;
wherein the radio access network comprises:
one of:
one or more microprocessors, volatile and non-volatile memory, and wireless receiver and transmitter which are communicatively connected via at least one data connection or bus, wherein the non-volatile memory comprises computer program instructions which, when executed by the one or more microprocessors control the wireless receiver and transmitter to establish, maintain, and terminate communication connections with one or more second communication apparatus, wherein the non-volatile memory further stores computer program instructions which when executed by the one or more microprocessors, configure the first communication apparatus to implement and perform operations comprising:
one of:
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus;
operating the first communication apparatus for configuring the second communication apparatus to receive small data transmission while the second communication apparatus is in a first operating mode in which electronic components necessary for receiving transmissions are periodically enabled for brief time periods and disabled in between, enabling and disabling being in accordance with a schedule scheme or paging cycle that is configured in accordance with information received from the first communication apparatus, by transmitting a paging message to the second communication apparatus, wherein the paging message includes or is complemented by a signal indicating properties of an impending small data transmission to the second communication apparatus, further comprising, if a periodic traffic pattern is indicated: transmitting the small data in the DL to the second communication apparatus in accordance with a periodicity of the traffic pattern also indicated in connection with the paging message, independently from the paging cycle;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein the properties of an impending small data transmission further comprise information concerning a configuration of radio resources which are used in connection with transmitting the small data in the DL;
operating the first communication apparatus for configuring the second communication apparatus to receive small data transmission while the second communication apparatus is in a first operating mode, in which electronic components necessary for receiving transmissions are periodically enabled for brief time periods and or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein, if an aperiodic traffic pattern is indicated, transmitting number of subsequent transmissions, or indicating, through a separate channel, a final transmission, to the second communication apparatus, after transmission of which the second communication apparatus does not listen for transmissions from the first communication apparatus in periodic intervals.
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein, if an aperiodic traffic pattern is indicated, transmitting the small data transmission to the second communication apparatus at occasions of the paging cycle, and
one or more microprocessors, volatile and non-volatile memory, and wireless receiver and transmitter, which are communicatively connected via at least one data connection or bus, wherein the non-volatile memory comprises computer program instructions which, when executed by the one or more microprocessors control the wireless receiver and transmitter to establish, maintain, and terminate communication connections with one or more second communication apparatus, wherein the non-volatile memory further stores computer program instructions which, when executed by the one or more microprocessors, configure the first communication apparatus to implement and perform operations comprising:
one of:
operating the first communication apparatus for configuring the second communication apparatus to receive small data transmission while the second communication apparatus is in a first operating mode in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus:
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, further comprising, if a periodic traffic pattern is indicated: transmitting the small data in the DL to the second communication apparatus in accordance with a periodicity of the traffic pattern also indicated in connection with the paging message, independently from the paging cycle;
operating the first communication apparatus for configuring the second communication apparatus to receive small data transmission while the second communication apparatus is in a first operating mode, in which electronic components necessary for receiving transmissions are periodically enabled for brief time periods and or paging cycle that is configured in accordance with information received from the first communication apparatus by transmitting a paging message to the second communication apparatus, wherein the paging message includes or is complemented by a signal indicating properties of an impending small data transmission to the second communication apparatus, wherein the properties of an impending small data transmission further comprise information concerning a configuration of radio resources which are used in connection with transmitting the small data in the DL;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein, if an aperiodic traffic pattern is indicated, transmitting number of subsequent transmissions, or indicating through a separate channel, a final transmission, to the second communication apparatus, after transmission of which the second communication apparatus does not listen for transmissions from the first communication apparatus in periodic intervals,
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein, if an aperiodic traffic pattern is indicated, transmitting the small data transmission to the second communication apparatus at occasions of the paging cycle;
wherein the first communication apparatus is further configured to establish, maintain, and terminate a wireless communication connection in accordance with 3GPP 5G and/or 6G standards.

14. A non-transitory computer-readable medium having stored thereon computer-executable instructions which, when executed by a microprocessor, cause the microprocessor and/or control hardware components of a first communication apparatus, or of a second communication apparatus perform operations comprising:
at least one of:
operating a first communication apparatus for configuring a second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus by transmitting a paging message to the second communication apparatus, wherein the paging message includes or is complemented by a signal indicating properties of an impending small data transmission to the second communication apparatus;
operating a first communication apparatus for configuring a second communication apparatus to receive small data transmission while the second communication apparatus is in a first operating mode, in which electronic components necessary for receiving transmissions are periodically enabled for brief time periods and disabled in between enabling and disabling being in accordance with a schedule scheme, or paging cycle that is configured in accordance with information received from the first communication apparatus by transmitting a paging message to the second communication apparatus. wherein the paging message includes or is complemented by a signal indicating properties of an impending small data transmission to the second communication apparatus, and, if a periodic traffic pattern is indicated: transmitting the small data in the DL to the second communication apparatus in accordance with a periodicity of the traffic pattern also indicated in connection with the paging message, independently from the paging cycle;
operating a first communication apparatus for configuring a second communication apparatus to receive small data transmission while the second communication apparatus is in a first operating mode, in which electronic components necessary for receiving transmissions are periodically enabled for brief time periods and disabled in between enabling and disabling being in accordance with a schedule, scheme, or paging cycle that is configured in accordance with information received from the first communication apparatus by transmitting a paging message to the second communication apparatus wherein the paging message includes or is complemented by a signal indicating properties of an impending small data transmission to the second communication apparatus, wherein the properties of an impending small data transmission further comprise information concerning a configuration of radio resources which are used in connection with transmitting the small data in the DL;
operating a first communication apparatus for configuring a second communication apparatus to receive small data transmission while the second communication apparatus is in a first operating mode, in which electronic components necessary for receiving transmissions are periodically enabled for brief time periods and disabled in between enabling and disabling being in accordance with a schedule, scheme, or paging cycle that is configured in accordance with information received from the first communication apparatus by transmitting a paging message to the second communication apparatus, wherein the paging message includes or is complemented by a signal indicating properties of an impending small data transmission to the second communication apparatus wherein. if an aperiodic traffic pattern is indicated transmitting number of subsequent transmissions, or indicating through a separate channel, a final transmission, to the second communication apparatus, after transmission of which the second communication apparatus stops listening for transmissions from the first communication apparatus in periodic intervals; and
operating a first communication apparatus for configuring a second communication apparatus to receive small data transmission while the second communication apparatus is in a first operating mode, in which electronic components necessary for receiving transmissions are periodically enabled for brief time periods and disabled in between, enabling and disabling being in accordance with a schedule scheme, or paging cycle that is configured in accordance with information received from the first communication apparatus by transmitting a paging message to the second communication apparatus, wherein the paging message includes or is complemented by a signal indicating properties of an impending small data transmission to the second communication apparatus wherein, if an aperiodic traffic pattern is indicated, the method further comprises transmitting the small data transmission to the second communication apparatus at occasions of the paging cycle,
or at least one of:
operating a second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by receiving, from the first communication apparatus and during a time period of the paging cycle, in which the electronic components necessary for receiving transmissions are enabled, a signal indicating properties of an impending small data transmission to the second communication apparatus;
operating a second communication apparatus for receiving small data transmission from a first communication apparatus, while the second communication apparatus is in a first operating mode, in which electronic components necessary for receiving transmissions are periodically enabled for brief time periods and disabled in between enabling and disabling being in accordance with a paging cycle configured in accordance with information received from the first communication apparatus by receiving from the first communication apparatus and during a time period of the paging cycle, in which the electronic components necessary for receiving transmissions are enabled, a signal indicating properties of an impending small data transmission to the second communication apparatus;
determining if the properties in the received signal indicate a periodic traffic pattern for the impending small data transmission to the second communication apparatus, and
if a periodic traffic pattern is indicated:
determining from the received signal, a periodicity of the traffic pattern, and
additionally enabling the electronic components necessary for receiving the small data transmission to the first communication apparatus in accordance with the periodicity of the traffic pattern, independently from the paging cycle;
operating a second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by receiving from the first communication apparatus and during a time period of the paging cycle, in which the electronic components necessary for receiving transmissions are enabled, a signal indicating properties of an impending small data transmission to the second communication apparatus, and, if a periodic traffic pattern is indicated:
determining, from the received signal, configuration information for radio resources used in connection with the small data transmission;
operating a second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus by receiving, from the first communication apparatus and during a time period of the paging cycle, in which the electronic components necessary for receiving transmissions are enabled, a signal indicating properties of an impending small data transmission to the second communication apparatus;
if a periodic traffic pattern is indicated:
receiving from the first communication apparatus, a number of subsequent transmissions, after completion of which the second communication apparatus does not listen for transmissions from the first communication apparatus in periodic intervals, or
receiving from the first communication apparatus, and through a separate channel, an indication of a final transmission, after completion of which the second communication apparatus does not listen for transmissions from the first communication apparatus in periodic intervals, and
accordingly cancelling additionally enabling the electronic components required for receiving transmissions from the first communication apparatus in accordance with the periodicity of the traffic pattern previously received;
operating a second communication apparatus for receiving small data transmission from a first communication apparatus, while the second communication apparatus is in a first operating mode, in which electronic components necessary for receiving transmissions are periodically enabled for brief time periods and disabled in between enabling and disabling being in accordance with a paging cycle configured in accordance with information received from the first communication apparatus by receiving from the first communication apparatus and during a time period of the paging cycle, in which the electronic components necessary for receiving transmissions are enabled, a signal indicating properties of an impending small data transmission to the second communication apparatus wherein, if an aperiodic traffic pattern is indicated, enabling the electronic components necessary for receiving transmissions, for receiving the small data transmission to the first communication apparatus in accordance with the paging cycle;
wherein the first communication apparatus of a radio access network comprises:
one of:
one or more microprocessors, volatile and non-volatile memory, and wireless receiver and transmitter, which are communicatively connected via at least one data connection or bus, wherein the non-volatile memory comprises computer program instructions which, when executed by the one or more microprocessors control the wireless receiver and transmitter to establish, maintain, and terminate communication connections with one or more second communication apparatus, wherein the non-volatile memory further stores computer program instructions which, when executed by the one or more microprocessors, configure the first communication apparatus to implement and perform operations comprising:
one of:
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, further comprising if a periodic traffic pattern is indicated: transmitting the small data in the DL to the second communication apparatus in accordance with a periodicity of the traffic pattern also indicated in connection with the paging message, independently from the paging cycle;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein the properties of an impending small data transmission further comprise information concerning a configuration of radio resources which are used in connection with transmitting the small data in the DL;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein, if an aperiodic traffic pattern is indicated, transmitting number of subsequent transmissions, or indicating through a separate channel, a final transmission, to the second communication apparatus, after transmission of which the second communication apparatus does not listen for transmissions from the first communication apparatus in periodic intervals; and
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus. wherein, if an aperiodic traffic pattern is indicated. transmitting the small data transmission to the second communication apparatus at occasions of the paging cycle:
and
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus;
operating the first communication apparatus for configuring the second communication apparatus to receive small data transmission while the second communication apparatus is in a first operating mode in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, further comprising if a periodic traffic pattern is indicated: transmitting the small data in the DL to the second communication apparatus in accordance with a periodicity of the traffic pattern also indicated in connection with the paging message, independently from the paging cycle;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule scheme, or paging cycle that is configured in accordance with information received from the first communication apparatus by transmitting a paging message to the second communication apparatus, wherein the paging message includes or is complemented by a signal indicating properties of an impending small data transmission to the second communication apparatus, wherein the properties of an impending small data transmission further comprise information concerning a configuration of radio resources which are used in connection with transmitting the small data in the DL;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus. wherein, if an aperiodic traffic pattern is indicated, transmitting number of subsequent transmissions, or indicating, through a separate channel, a final transmission, to the second communication apparatus, after transmission of which the second communication apparatus does not listen for transmissions from the first communication apparatus in periodic intervals;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule scheme, or paging cycle that is configured in accordance with information received from the first communication apparatus by transmitting a paging message to the second communication apparatus, wherein the paging message includes or is complemented by a signal indicating properties of an impending small data transmission to the second communication apparatus, wherein, if an aperiodic traffic pattern is indicated, transmitting the small data transmission to the second communication apparatus at occasions of the paging cycle; and
wherein the first communication apparatus is further configured to establish, maintain, and terminate a wireless communication connection in accordance with 3GPP 5G and/or 6G standards;
wherein the second communication apparatus comprises one or more microprocessors volatile and non-volatile memory, and wireless receiver and transmitter which are communicatively connected via at least one data connection or bus, wherein the non-volatile memory comprises computer program instructions which, when executed by the one or more microprocessors control the wireless receiver and transmitter to establish, maintain, and terminate communication connections with a first communication apparatus of a radio access network, wherein the non-volatile memory further stores computer program instructions which, when executed by the one or more microprocessors, configure the second communication apparatus to implement and perform operations comprising:
one of:
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving, from the first communication apparatus and during a time period of the paging cycle, in which the electronic components necessary for receiving transmissions are enabled, a signal indicating properties of an impending small data transmission to the second communication apparatus;
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving from the first communication apparatus and during a time period of the paging cycle, in which the electronic components necessary for receiving transmissions are enabled, a signal indicating properties of an impending small data transmission to the second communication apparatus,
determining, if the properties in the received signal indicate a periodic traffic pattern for the impending small data transmission to the second communication apparatus. and if a periodic traffic pattern is indicated:
determining from the received signal, a periodicity of the traffic pattern, and additionally enabling the electronic components necessary for receiving the small data transmission to the first communication apparatus in accordance with the periodicity of the traffic pattern, independently from the paging cycle;
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving, from the first communication apparatus and during a time period of the paging cycle, in which the electronic components necessary for receiving transmissions are enabled, a signal indicating properties of an impending small data transmission to the second communication apparatus, and if a periodic traffic pattern is indicated;
determining, from the received signal, configuration information for radio resources used in connection with the small data transmission;
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving, from the first communication apparatus and during a time period of the paging cycle, in which the electronic components necessary for receiving transmissions are enabled, a signal indicating properties of an impending small data transmission to the second communication apparatus, and if a periodic traffic pattern is indicated
receiving, from the first communication apparatus, a number of subsequent transmissions, after completion of which the second communication apparatus does not listen for transmissions from the first communication apparatus in periodic intervals, or
receiving, from the first communication apparatus, and through a separate channel, an indication of a final transmission, after completion of which the second communication apparatus does not listen for transmissions from the first communication apparatus in periodic intervals, and
accordingly cancelling additionally enabling the electronic components required for receiving transmissions from the first communication apparatus in accordance with the periodicity of the traffic pattern previously received,
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving from the first communication apparatus and during a time period of the paging cycle in which the electronic components necessary for receiving transmissions are enabled, a signal indicating properties of an impending small data transmission to the second communication apparatus, wherein, if an aperiodic traffic pattern is indicated, enabling the electronic components necessary for receiving transmissions, for receiving the small data transmission to the first communication apparatus in accordance with the paging cycle;
wherein the radio access network comprises:
one of:
one or more microprocessors, volatile and non-volatile memory, and wireless receiver and transmitter which are communicatively connected via at least one data connection or bus, wherein the non-volatile memory comprises computer program instructions which, when executed by the one or more microprocessors control the wireless receiver and transmitter to establish, maintain and terminate communication connections with one or more second communication apparatus, wherein the non-volatile memory further stores computer program instructions which, when executed by the one or more microprocessors, configure the first communication apparatus to implement and perform operations comprising:
one of:
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus;
operating the first communication apparatus for configuring the second communication apparatus to receive small data transmission while the second communication apparatus is in a first operating mode in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, further comprising, if a periodic traffic pattern is indicated: transmitting the small data in the DL to the second communication apparatus in accordance with a periodicity of the traffic pattern also indicated in connection with the paging message, independently from the paging cycle;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein the properties of an impending small data transmission further comprise information concerning a configuration of radio resources which are used in connection with transmitting the small data in the DL;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein, if an aperiodic traffic pattern is indicated, transmitting number of subsequent transmissions, or indicating, through a separate channel, a final transmission to the second communication apparatus, after transmission of which the second communication apparatus does not listen for transmissions from the first communication apparatus in periodic intervals,
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule scheme or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein, if an aperiodic traffic pattern is indicated. transmitting the small data transmission to the second communication apparatus at occasions of the paging cycle; and
one or more microprocessors, volatile and non-volatile memory, and wireless receiver and transmitter, which are communicatively connected via at least one data connection or bus, wherein the non-volatile memory comprises computer program instructions which, when executed by the one or more microprocessors control the wireless receiver and transmitter to establish, maintain, and terminate communication connections with one or more second communication apparatus, wherein the non-volatile memory further stores computer program instructions which, when executed by the one or more microprocessors, configure the first communication apparatus to implement and perform operations comprising:
one of:
operating the first communication apparatus for configuring the second communication apparatus to receive small data transmission while the second communication apparatus is in a first operating mode in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus:
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, further comprising, if a periodic traffic pattern is indicated: transmitting the small data in the DL to the second communication apparatus in accordance with a periodicity of the traffic pattern also indicated in connection with the paging message, independently from the paging cycle;
operating the first communication apparatus for configuring the second communication apparatus to receive small data transmission while the second communication apparatus is in a first operating mode, in which electronic components necessary for receiving transmissions are periodically enabled for brief time periods and or paging cycle that is configured in accordance with information received from the first communication apparatus by transmitting a paging message to the second communication apparatus, wherein the paging message includes or is complemented by a signal indicating properties of an impending small data transmission to the second communication apparatus, wherein the properties of an impending small data transmission further comprise information concerning a configuration of radio resources which are used in connection with transmitting the small data in the DL;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein, if an aperiodic traffic pattern is indicated, transmitting number of subsequent transmissions, or indicating through a separate channel, a final transmission, to the second communication apparatus, after transmission of which the second communication apparatus does not listen for transmissions from the first communication apparatus in periodic intervals,
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein, if an aperiodic traffic pattern is indicated, transmitting the small data transmission to the second communication apparatus at occasions of the paging cycle;
wherein the first communication apparatus is further configured to establish, maintain, and terminate a wireless communication connection in accordance with 3GPP 5G and/or 6G standards.

15. (canceled)

16. A vehicle having a second communication apparatus comprising one or more microprocessors, volatile and non-volatile memory and wireless receiver and transmitter which are communicatively connected via at least one data connection or bus, wherein the non-volatile memory comprises computer program instructions which, when executed by the one or more microprocessors control the wireless receiver and transmitter to establish, maintain, and terminate communication connections with a first communication apparatus of a radio access network, wherein the non-volatile memory further stores computer program instructions which, when executed by the one or more microprocessors, configure the second communication apparatus to implement and perform operations comprising:
one of:
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving, from the first communication apparatus and during a time period of the paging cycle, in which the electronic components necessary for receiving transmissions are enabled, a signal indicating properties of an impending small data transmission to the second communication apparatus;
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving from the first communication apparatus and during a time period of the paging cycle, in which the electronic components necessary for receiving transmissions are enabled, a signal indicating properties of an impending small data transmission to the second communication apparatus,
determining, if the properties in the received signal indicate a periodic traffic pattern for the impending small data transmission to the second communication apparatus, and if a periodic traffic pattern is indicated;
determining from the received signal, a periodicity of the traffic pattern, and additionally enabling the electronic components necessary for receiving the small data transmission to the first communication apparatus in accordance with the periodicity of the traffic pattern, independently from the paging cycle;
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving from the first communication apparatus and during a time period of the paging cycle in which the electronic components necessary for receiving transmissions are enabled, a signal indicating properties of an impending small data transmission to the second communication apparatus, and if a periodic traffic pattern is indicated:
determining, from the received signal, configuration information for radio resources used in connection with the small data transmission;
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving, from the first communication apparatus and during a time period of the paging cycle, in which the electronic components necessary for receiving transmissions are enabled, a signal indicating properties of an impending small data transmission to the second communication apparatus, and if a periodic traffic pattern is indicated;
receiving, from the first communication apparatus, a number of subsequent transmissions, after completion of which the second communication apparatus does not listen for transmissions from the first communication apparatus in periodic intervals, or
receiving, from the first communication apparatus, and through a separate channel an indication of a final transmission, after completion of which the second communication apparatus does not listen for transmissions from the first communication apparatus in periodic intervals, and
accordingly cancelling additionally enabling the electronic components required for receiving transmissions from the first communication apparatus in accordance with the periodicity of the traffic pattern previously received.
operating the second communication apparatus for receiving small data transmission from a first communication apparatus, while the second communication apparatus is in a first operating mode, in which electronic components necessary for receiving transmissions are periodically enabled for brief time periods and disabled in between, enabling and disabling being in accordance with a paging cycle configured in accordance with information received from the first communication apparatus, by receiving, from the first communication apparatus and during a time period of the paging cycle, in which the electronic components necessary for receiving transmissions are enabled, a signal indicating properties of an impending small data transmission to the second communication apparatus, wherein, if an aperiodic traffic pattern is indicated, enabling the electronic components necessary for receiving transmissions, for receiving the small data transmission to the first communication apparatus in accordance with the paging cycle;
wherein the radio access network comprises:
one of:
one or more microprocessors, volatile and non-volatile memory, and wireless receiver and transmitter which are communicatively connected via at least one data connection or bus, wherein the non-volatile memory comprises computer program instructions which, when executed by the one or more microprocessors control the wireless receiver and transmitter to establish, maintain, and terminate communication connections with one or more second communication apparatus, wherein the non-volatile memory further stores computer program instructions which, when executed by the one or more microprocessors, configure the first communication apparatus to implement and perform operations comprising:
one of:
operating the first communication apparatus for configuring the second communication apparatus to receive small data transmission while the second communication apparatus is in a first operating mode in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus:
operating the first communication apparatus for configuring the second communication apparatus to receive small data transmission while the second communication apparatus is in a first operating mode in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, further comprising, if a periodic traffic pattern is indicated: transmitting the small data in the DL to the second communication apparatus in accordance with a periodicity of the traffic pattern also indicated in connection with the paging message, independently from the paging cycle;
operating the first communication apparatus for configuring the second communication apparatus to receive small data transmission while the second communication apparatus is in a first operating mode in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein the properties of an impending small data transmission further comprise information concerning a configuration of radio resources which are used in connection with transmitting the small data in the DL;
operating the first communication apparatus for configuring the second communication apparatus to receive small data transmission while the second communication apparatus is in a first operating mode in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus. wherein the paging message includes or is complemented by a signal indicating properties of an impending small data transmission to the second communication apparatus, wherein, if an aperiodic traffic pattern is indicated, transmitting number of subsequent transmissions, or indicating, through a separate channel, a final transmission, to the second communication apparatus, after transmission of which the second communication apparatus does not listen for transmissions from the first communication apparatus in periodic intervals.
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein, if an aperiodic traffic pattern is indicated, transmitting the small data transmission to the second communication apparatus at occasions of the paging cycle; and
one or more microprocessors, volatile and non-volatile memory, and wireless receiver and transmitter, which are communicatively connected via at least one data connection or bus, wherein the non-volatile memory comprises computer program instructions which, when executed by the one or more microprocessors control the wireless receiver and transmitter to establish, maintain, and terminate communication connections with one or more second communication apparatus, wherein the non-volatile memory further stores computer program instructions which, when executed by the one or more microprocessors, configure the first communication apparatus to implement and perform operations comprising:
one of:
operating the first communication apparatus for configuring the second communication apparatus to receive small data transmission while the second communication apparatus is in a first operating mode in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule scheme or paging cycle that is configured in accordance with information received from the first communication apparatus, by transmitting a paging message to the second communication apparatus, wherein the paging message includes or is complemented by a signal indicating properties of an impending small data transmission to the second communication apparatus, further comprising, if a periodic traffic pattern is indicated: transmitting the small data in the DL to the second communication apparatus in accordance with a periodicity of the traffic pattern also indicated in connection with the paging message, independently from the paging cycle;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein the properties of an impending small data transmission further comprise information concerning a configuration of radio resources which are used in connection with transmitting the small data in the DL;
operating the first communication apparatus for configuring the second communication apparatus to receive small data transmission while the second communication apparatus is in a first operating mode, in which electronic components necessary for receiving transmissions are periodically enabled for brief time periods and disabled in between, enabling and disabling being in accordance with a schedule scheme or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein, if an aperiodic traffic pattern is indicated, transmitting number of subsequent transmissions, or indicating, through a separate channel, a final transmission to the second communication apparatus, after transmission of which the second communication apparatus does not listen for transmissions from the first communication apparatus in periodic intervals,
operating the first communication apparatus for configuring the second communication apparatus to receive small data transmission while the second communication apparatus is in a first operating mode in which electronic components necessary for receiving transmissions are periodically enabled for brief time periods and disabled in between, enabling and disabling being in accordance with a schedule, scheme, or paging cycle that is configured in accordance with information received from the first communication apparatus, by transmitting a paging message to the second communication apparatus, wherein the paging message includes or is complemented by a signal indicating properties of an impending small data transmission to the second communication apparatus, wherein, if an aperiodic traffic pattern is indicated, transmitting the small data transmission to the second communication apparatus at occasions of the paging cycle;
wherein the first communication apparatus is further configured to establish, maintain, and terminate a wireless communication connection in accordance with 3GPP 5G and/or 6G standards.
